(19) United States
(12) Patent Application Publication
(10) Pub. No.: US 2021/0021548 A1
(43) Pub. Date: Jan. 21, 2021

(54) TEXT MESSAGING ELECTRONIC DEVICE AND SERVER COMPUTER FOR REGISTERING CONTEXT

(71) Applicant: Ryan DICKSON, Cambridge (CA)

(72) Inventor: Ryan DICKSON, Cambridge (CA)

(21) Appl. No.: 16/511,948

(22) Filed: Jul. 15, 2019

(51) Int. Cl. H04L 12/58; G06F 3/0481; G06F 16/31

(52) U.S. Cl. CPC H04L 51/046; G06F 16/31; G06F 3/04817

(57) ABSTRACT

A text messaging electronic device and a text messaging server for registering context, and a method for operating the same are provided. The text messaging electronic device includes at least one processor, a display coupled to the processor, a text input interface coupled to the processor, a network interface coupled to the processor, and a storage storing computer-readable instructions for causing the at least one processor to execute a text messaging application, the text messaging application having a message display interface, a message creation interface that presents text entered via the text input interface, and at least one context selector control enabling at least one context to be associated with the text being entered in the message creation interface, the message display interface presenting received text messages and any context identifiers for any contexts associated with the received text messages received from other text messaging systems via the network interface.

### FIELD

The specification relates generally to messaging, and, in particular, to a context-expressing text messaging system.

### BACKGROUND OF THE DISCLOSURE

Text messaging has become a main mode of communication for many people. It has become more convenient to carry on conversations via text messaging applications for a number of reasons. Mobile computing devices are ubiquitous and relatively less inexpensive than before, making a reliance on a landline less prevalent. With busier schedules, it can be difficult to find a block of time that is free for two people to have a voice conversation. Text messaging is thus appealing, as it enables asynchronous communication, with no need to communicate simultaneously. Further, in some cases, text messaging enables each person to have a record of what was said so that an agreed-upon appointment time and location can be easily verified, etc.

Text messaging, while convenient, does suffer from various issues. When conducting a voice conversation with another person, tonal queues can provide contextual information for interpreting spoken words and phrases. Such contextual information is not present in text messaging, and, as a result, text messaging can be confusing in some circumstances. For example, a phrase intended as a joke can be read as a serious statement. As a result, the recipient may be left with the wrong impression, the person transmitting may end up needing to explain the joke via additional text messages, etc.

### SUMMARY OF THE DISCLOSURE

In one aspect, there is provided a text messaging electronic device for registering context, comprising: at least one processor; a display coupled to the processor; a text input interface coupled to the processor; a network interface coupled to the processor; and a storage storing computer-readable instructions that, when executed by the at least one processor, cause the at least one processor to execute a text messaging application, the text messaging application having a message display interface and a message creation interface, the message creation interface presenting text entered via the text input interface, and at least one context selector control enabling at least one context to be associated with the text being entered in the message creation interface, the message display interface presenting received text messages and any context identifiers for any contexts associated with the received text messages received from other text messaging systems via the network interface.

The at least one context selector control can include at least one activatable button. The at least one activatable button can be toggleable between an activated mode and a deactivated mode, and, when one of the at least one activatable button is in an activated mode, an associated context identifier associated with the one of the at least one activatable button can be registered with the text being entered, the context identifier being transmitted with the text message when the text message is sent via the network interface.

A portion of the text being entered can be selected and one of the at least one activatable button is activated, the context identifier associated with the one of the at least one activatable button being registered with the text being entered, the context identifier being transmitted with the text when the text is sent via the network interface.

The at least one activatable button can include at least one activatable icon. Each of the at least one activatable icon can convey the context associated with the activatable icon.

In another aspect, there is provided a server computer storing text and context, comprising at least one processor, a display coupled to the processor, a network interface coupled to the processor, and a storage storing a plurality of text messages, and for each of the plurality of text strings, a sender identifier and at least one recipient identifier, a set of context identifiers identifying at least one context for portions of the plurality of text strings, and computer-readable instructions that, when executed by the at least one processor, cause the at least one processor to execute a server application, the server application receiving text strings and context identifiers identifying at least one context for portions of the text strings.

The plurality of text strings can include text messages, and the server computer can store a sender account identifier and at least one recipient account identifier for each text message, and communicating, via the network interface, a subset of the text messages to an electronic device together with the context identifiers identifying at least one context for portions of the subset of the text messages.

In a further aspect, there is provided an electronic device enabling text and context entry, comprising at least one processor, a display coupled to the processor, a text input interface coupled to the processor, a network interface coupled to the processor, and a storage storing computer-readable instructions that, when executed by the at least one processor, cause the at least one processor to execute a text entry application, the text entry application having a text string creation interface presenting text entered via the text input interface, and at least one context selector control enabling at least one context to be associated with the text being entered in the text string creation interface.

The at least one context selector control can include at least one activatable button.

The at least one activatable button can be toggleable between an activated mode and a deactivated mode, and, when one of the at least one activatable button is in an activated mode, an associated context identifier associated with the one of the at least one activatable button can be registered with the text being entered, the context identifier being transmitted with the text when the text is sent via the network interface.

When a portion of the text being entered is selected and one of the at least one activatable button is activated, the context identifier associated with the one of the at least one activatable button can be registered with the text being entered, the context identifier being transmitted with the text when the text is sent via the network interface.

The at least one activatable button can include at least one activatable icon.

Each of the at least one activatable icon can convey the context associated with the activatable icon.

In a still further aspect, there is provided a method of operating a text messaging electronic device for registering context, comprising: executing a text messaging application via at least one processor of a text messaging electronic device; providing a text input interface enabling a user of the electronic device to enter text; presenting, via a display of the text messaging electronic device, a message creation interface presenting text entered via the input interface; providing at least one context selector control enabling at least one context to be associated with the text being entered via the text input interface in the message creation interface; and presenting, via the display of the text messaging electronic device, a message display interface presenting text messages received and any context identifiers for any contexts associated with the received text messages received from other text messaging systems via a network communications interface of the text messaging electronic device.

The providing of the at least one context selector control can include presenting the at least one context selector control on the display of the text messaging electronic device. The at least one context selector control can include at least one activatable button. The at least one activatable button can be toggleable between an activated mode and a deactivated mode, and, when one of the at least one activatable button is in an activated mode, an associated context identifier associated with the one of the at least one activatable button can be registered with the text being entered, the context identifier being transmitted with the text when the text is sent via the network interface.

When a portion of the text being entered is selected and one of the at least one activatable button is activated, the context identifier associated with the one of the at least one activatable button can be registered with the text being entered, the context identifier being transmitted with the text when the text is sent via the network interface.

The at least one activatable button can include at least one activatable icon. Each of the at least one activatable icon can convey the context associated with the activatable icon.

Other technical advantages may become readily apparent to one of ordinary skill in the art after review of the following figures and description.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

FIG. 1 shows a set of text messaging electronic devices in communication with a text messaging server computer and their operating environment in accordance with one embodiment thereof;

FIG. 2 is a schematic diagram showing various physical and logical components of the text messaging electronic device of FIG. 1;

FIG. 3 is a schematic diagram showing various physical and logical components of the text messaging server computer of FIG. 1;

FIGS. 4A to 4E show the user interface of the text messaging application in use on two text messaging electronic devices transmitting text messages to each other;

FIGS. 5A and 5B show the general methods carried out by the text messaging electronic devices of FIGS. 1 and 2 when context controls are activated and deactivated; and

FIG. 6 shows a help screen of the text messaging application that provides a more detailed reference of what each context is.

Unless otherwise specifically noted, articles depicted in the drawings are not necessarily drawn to scale.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

A text message as referred to herein is a text string of one or more characters entered by a person via an electronic device. The text message may be directed to another person operating a client, but can also be directed to no particular user and used in combination with contextual metadata provided therewith by a computing device presenting the text message to provide contextual information about the text string or portions thereof. The contextual information can be provided by text decoration, such as the color of the text, the size, appearance, animation, etc. Further, the text messages and contextual metadata can be used to enable a text-to-speech engine to modify the playback of the text message via simulated speech.

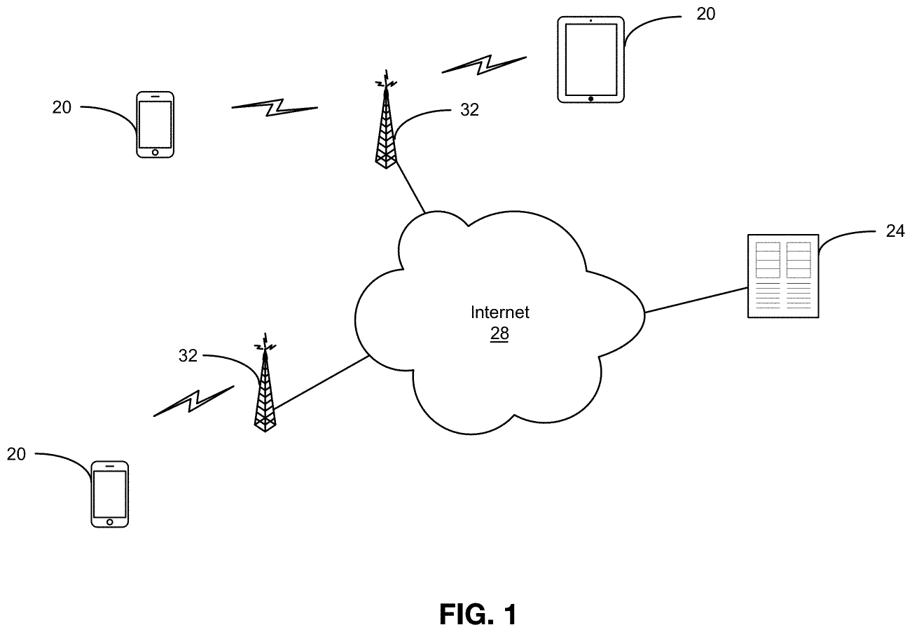

An exemplary text messaging system is shown in FIG. 1 and includes a set of text messaging electronic devices 20. The text messaging electronic devices 20 can be any type of computing device that is coupleable to a data communications network and has an input interface for receiving input including text messages from a user and a display for at least presenting text messages from other text messaging electronic devices 20. In the illustrated embodiment, the text messaging electronic devices 20 are mobile smart phones and network-coupled tablets, but in other embodiments can be, for example, personal desktop and laptop computers, and wearable computing devices such as smart watches.

The text messaging electronic devices 20 are in communication with a text messaging server computer 24 over a data communications network such as the Internet 28. In the illustrated embodiment, each of the text messaging electronic devices 20 are configured with cellular communications radios and communicate over the Internet 28 via cellular base stations 32, and various infrastructure hardware, as will be appreciated.

The text messaging electronic device 20 is coupled to a computer network, which can be a public or private network. In the illustrated embodiment, the computer network is the Internet 24.

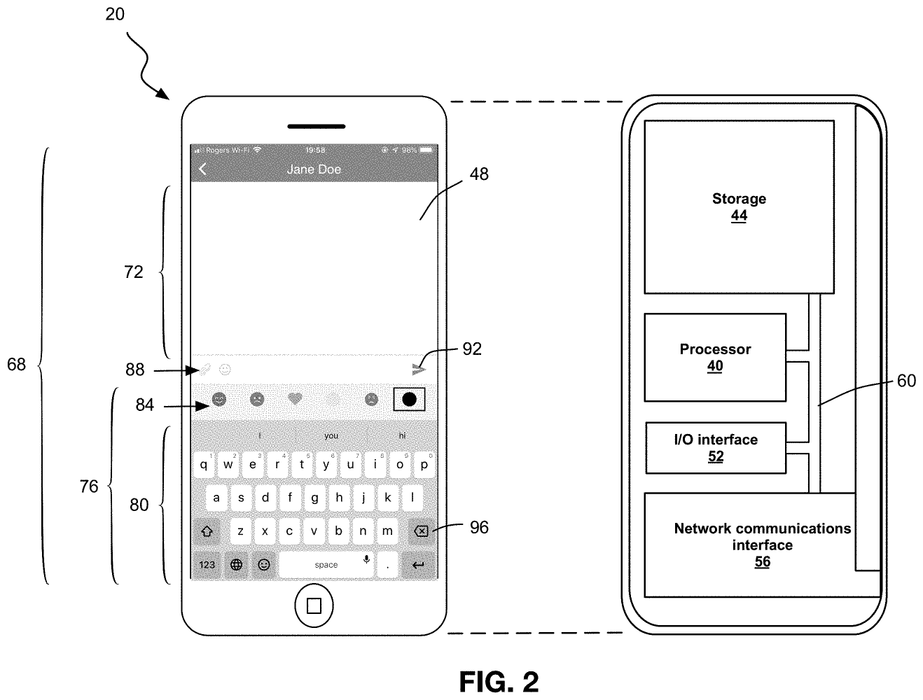

FIG. 2 shows various physical elements of the text messaging electronic device 20. As shown, the text messaging electronic device 20 has a number of physical and logical components, including a processor 40, storage 44, a touchscreen display 48, an input/output (“I/O”) interface 52, a network communications interface 56, and a local bus 60 enabling the processor 40 to communicate with the other components. The processor 40 executes at least an operating system stored in storage 44. The processor 40 can be any type of processor that is suitable to execute instructions to present a text messaging application graphical user interface, receive text input and corresponding context information for the text input via a user input interface and a network communications interface, as will be described hereinafter. Further, in place of a single processor, two or more processors can be employed to perform the functionality described herein.

The storage 44 includes both relatively responsive storage and permanent storage that are accessible to the processor 40. These storage types can be varied by one skilled in the art without impacting the working of the system. The storage 44 stores the operating system and programs, including computer-executable instructions for implementing a text messaging application as will be described herein below. During operation of the text messaging electronic device 20, the operating system, the programs and the data may be retrieved from a first area of the storage 44 and placed in a second area of the storage 44 to facilitate execution.

The touchscreen display 48 integrates a physical user input interface with an output interface in the form of a display. The touchscreen display 48 can be any form of a variety of touch displays, such as a resistive touchscreen panel, a capacitive touchscreen panel, etc. In alternative embodiments, additional or alternative user input interfaces, such as a keyboard, can be used to augment or replace the input functionality of the touchscreen display 48. In further alternative embodiments, additional physical displays and input devices, such as an external wired or wireless keyboard and/or mouse, trackpad, etc., can be coupled to the text messaging electronic device 20.

The I/O interface 52 manages the input received from the touchscreen display 48. allows for input to be received from one or more devices, such as a keyboard, a mouse, etc., and outputs information to output devices, such as a display and/or speakers. A network communications interface 56 permits communication with other computing devices over data communications networks such as the Internet 24. The network communications interface 56 can be configured for wired and/or wireless communications. For example, the network communications interface 56 can include a radio frequency (“RF”) radio for bidirectional wireless communications via cellular data communications. Alternatively, the RF radio can be configured for Wi-Fi, Bluetooth, or some other suitable wireless network scheme. In a further example, the network communications interface 56 can be a wired communications interface, such as, for example, for communicating via CAT6 cables or the like. Any suitable protocol can be used by the network communications interface 56 to communicate with other electronic devices 20 and/or the text messaging server computer 24.

As noted, the text messaging electronic device 20 executes a text messaging application that presents a user interface 68 on the touchscreen display 48 of the text messaging electronic device 20. The user interface 68 includes a message display interface 72 where text messages received from other text messaging electronic devices 20 are displayed inline with text messages generated by the text messaging electronic device 20.

The text messaging electronic device 20, when executing the text messaging application, also includes a message creation interface 76. In the illustrated embodiment, the message creation interface 76 includes a software keyboard 80 presented in a lower region of the touchscreen display 48. The software keyboard 80 can be a standard keyboard provided by the operating system of the text messaging electronic device 20, a custom keyboard installed for the operating system, or can be a keyboard that forms part of the text messaging application and is only presented when the text messaging application is executed by the text messaging electronic device 20. The software keyboard enables entry of text by a user.

In addition, the message creation interface 76 includes at least one context selector control 84 enabling at least one context to be associated with the text being entered via the soft keyboard 80 and presented in a message composition region 88. In the illustrated embodiment, the context selector controls 84 are software controls in the form of buttons that are presented on the touchscreen display 48 and are activatable by a user via touch. As illustrated, there are six context controls 84 that are presented. Each of the context controls 84 includes an icon that represents a context, and is depicted in a color that varies from the colors of the other context controls 84. A first of the context controls 84 includes a smiling face icon and is presented in green, representing a happy, agreeable, positive context. A second of the context controls 84 includes a frowning face icon and is presented in blue, representing a sad, disagreeable, negative context. A third of the context controls 84 includes a pink heart, representing a romantic context. A fourth of the context controls 84 includes a yellow laughing face, representing a humorous or sarcastic context. A fifth of the context controls 84 includes a red angry face, representing an angry or frustrated context. A sixth of the context controls 84 is a black circle, representing a generic context.

In a default mode, the context controls 84 can be exclusively activated like radio buttons so that one and only one of the context controls 84 is activated at any time. The activated context control 84 is highlighted by a rectangle being drawn around the particular context control 84. The text messaging application, by default, starts with the generic context control 84 being activated.

A send control 92 enables a user to transmit a text message composed in the message composition region 88. A return key 96 on the soft keyboard can be configured to send the text message as well.

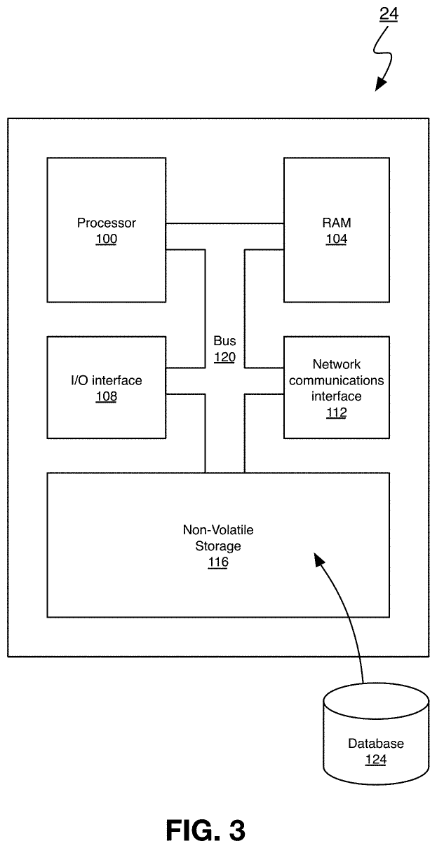

Now, with reference to FIG. 3, various components of the text messaging server computer 24 are shown in greater detail. As shown, the text messaging server computer 24 has a number of physical and logical components, including a processor 100, random access memory (“RAM”) 104, an input/output (“I/O”) interface 108, a network communications interface 112, non-volatile storage 116, and a local bus 120 enabling processor 100 to communicate with the other components. The processor 100 executes an operating system, and a text messaging server application, and can be any suitable processor. Further, in other embodiments, two or more processors can be employed to perform the tasks of the processor 100. RAM 104 provides relatively-responsive volatile storage to the processor. The I/O interface 108 allows for input to be received from one or more devices, such as a keyboard, a mouse, etc., and outputs information to output devices, such as a display and/or speakers. The network communications interface 112 permits communication with other systems, such as the text messaging electronic devices 20. In the particular illustrated embodiment of FIG. 1, the network communications interface 112 is configured for wired communications via Ethernet cable. Non-volatile storage 116 stores the operating system and programs, including computer-executable instructions for implementing the text messaging server application, and the text messaging server application's data. During operation of the text messaging server computer 24, the operating system, the programs and the data may be retrieved from the non-volatile storage 116 and placed in RAM 104 to facilitate execution.

While, in this exemplary embodiment, the text messaging server computer 24 is shown and described as a single physical computer, in other embodiments, the text messaging server computer 24 can be two or more proximate or remotely located physical computers that act cooperatively to provide the functionality of the text messaging server computer 24.

The text messaging server computer 24 maintains a database 124 of a plurality of text messages, a sender identifier and at least one recipient identifier, a set of context identifiers identifying at least one context for portions of the plurality of text messages. In the current embodiment, a portion of a text message that is associated with a context by a user is identified by registering the corresponding context identifier with a starting position and, where the portion of the text message does not extend to the end of the text message, an ending position. The text messaging electronic device 20 makes these registrations based on the activation and deactivation of the context controls, as will now be described. The database 124 can be any form of data that is suitable to store a set of text messages and corresponding context metadata, including, for example, a traditional relational database, a text file, etc. In the present embodiment, the database 124 also stores a list of user profiles that each text message can identify as a sender and/or a recipient.

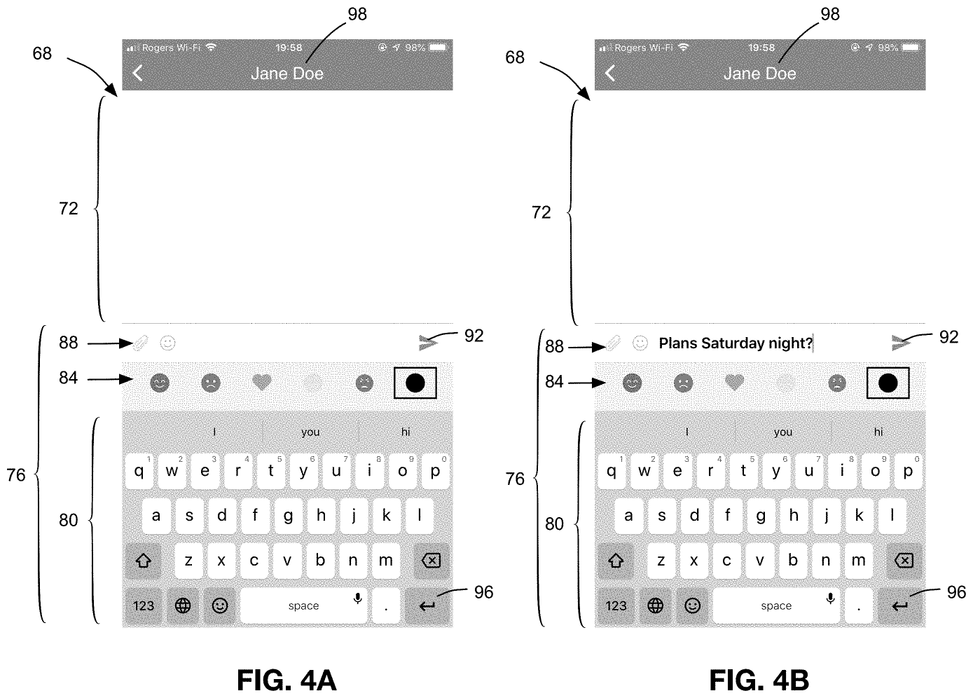

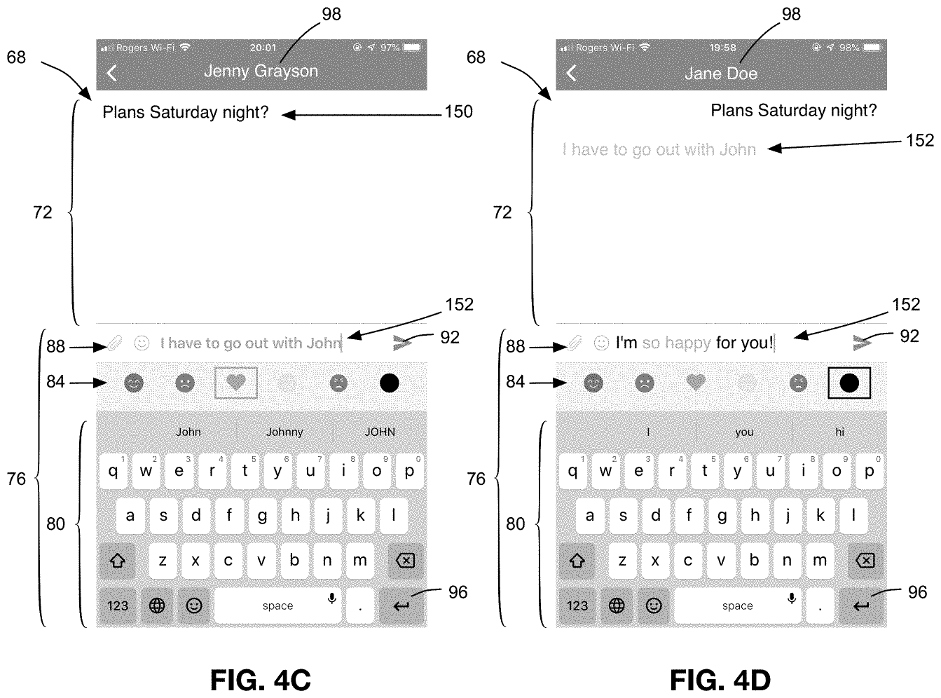

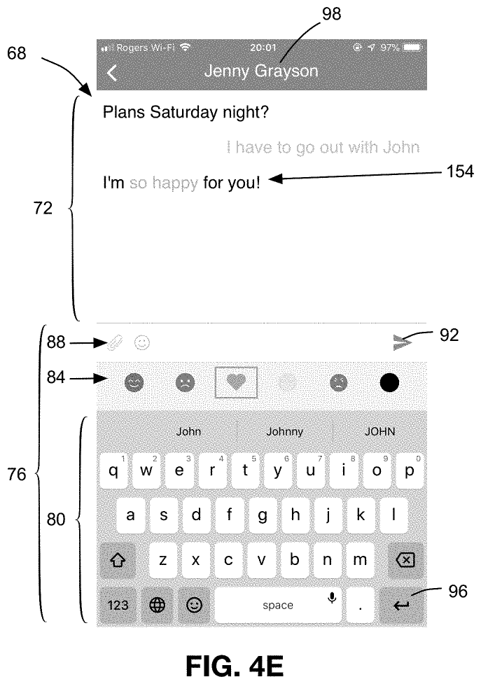

FIG. 4A shows the user interface 68 presented by the text messaging application executing on a first text messaging electronic device 20 as previously shown in FIG. 2 when a user selects to initiate a new text messaging discussion. The sixth context controls 84, the black circle, representing a generic context is activated by default. The user interface 68 indicates the name 98 of the person or group of persons with which the user is communicating via the text messaging system.

FIG. 4B shows the user interface 68 of FIG. 4A on the first text messaging electronic device 20 after the user has used the software keyboard to enter some text while the sixth context control 84 is activated. The entered text is shown in black in the message composition region 88 of the user interface 68, matching the color of the context control 84 activated during the time that the text was entered. Upon selecting to send the entered text as a text message either via activation of the send control 92 or a return key 96 on the soft keyboard 80. When the text message is sent, the text messaging application does not send context identifiers as the entire text message has been entered with the default generic context. The text message and corresponding context metadata is sent to the text messaging server 24 and is stored in the database 124.

FIG. 4C shows the user interface 68 presented by the text messaging application executing on a second text messaging electronic device 20 that is the recipient of the text message sent in FIG. 4B. The text message 150 transmitted by the first sender is retrieved from the text messaging server 24 and appears in the message display interface 72. Upon receipt of the text message, the text messaging application determines that there are no context identifiers provided with the text message. As a result, the text messaging application determines that the context of the text message is the default context; that is, generic. The text messaging application then presents the text message 150 in the corresponding color, black. As shown, the third context control 84, a pink heart, representing a romantic context is activated and has a rectangle drawn around it. A string of text is shown as having been entered in the message composition region 88 of the text messaging application user interface 68 while the third context control 84 was activated. As a result, the entire text string in the message composition region 88 is pink in color.

When the user activates the send button 92, the text messaging application transmits the text message together with a context identifier for the third context, as well as the range of text in the text message to which the context identifier applies. In the present embodiment, the metadata transmitted by the text messaging application is “[context:romantic from:0 to:26]”, indicating both the starting position and the end position for the text string to which the context identifier, “context:romantic”, applies. In an alternative embodiment, the metadata transmitted can be, for example, “[context:romantic from:0]”, with the missing end position of the context being understood to mean that the remainder of the text message from position 0 onwards has the romantic context applied to it. In a further alternative embodiment, the metadata transmitted for this scenario can be “[context:romantic]”, which can be understood to indicate that the romantic context applies to the entire text message. The user can then send the text message by activating the send control 92 or the return key 96. Upon receipt, the text messaging server 24 stores the text message and corresponding context data in the database 124.

FIG. 4D shows the user interface 68 presented by the text messaging application executing on the first text messaging electronic device 20. The text message 152 transmitted by the second sender appears in the message display interface 72. Upon receipt of the text message, the text messaging application determines that there is a context identifier provided with the text message, together with its scope, “[context:romantic start:0 end:26]”. As a result, the text messaging application determines that the context of the text message is the romantic context. The text messaging application then presents the entire text message 150 in the corresponding color, pink.

The message composition region 88 shows a text string having been entered by the user of the first text messaging electronic device 20. As shown, the sixth context control 84, the black circle, representing a generic context is activated and has a rectangle drawn around it. The text string in the message composition region 88 is black at the start and the end, but a portion of the text string, “so happy”, is in yellow. In order to effect this, the user has typed the entire message with the sixth context control 84 activated, has selected the phrase “so happy”, and has activated the fourth context control 84, associated with the humor context. As a result, the portion of the text string, “so happy”, is shown in yellow, the color associated with the fourth context. The text messaging application registers the context metadata for this text message as “[context:humor start:4 end:12]”. Upon activating the send control 92 or the return key 96, the text message and the context metadata is sent to the text messaging server 24. The text messaging server 24 then stores the text message and the corresponding context metadata in the database 124.

FIG. 4E shows the user interface 68 presented by the text messaging application executing on the second text messaging electronic device 20. The text message 154 transmitted by the first sender appears in the message display interface 72. Upon receipt of the text message, the text messaging application determines that there is a context identifier provided with the text message, together with its scope, “[context:humor start:4 end:12]”. As a result, the text messaging application determines that the context of the text message is the humor context. As a result, the text messaging application then presents the first four characters of the string in the color associated with the default context, black, the next eight characters of the string in the color associated with the humor context, yellow, and the last nine characters of the text message in the color associated with the default context, black.

When the user activates the send button 92, the text messaging application transmits the text message together with a context identifier for the third context, as well as the range of text in the text message to which the context identifier applies. In the present embodiment, the metadata transmitted by the text messaging application is “[context:romantic from:0 to:26]”, indicating both the starting position and the end position for the text string to which the context identifier, “context:romantic”, applies. In an alternative embodiment, the metadata transmitted can be, for example, “[context:romantic from:0]”, with the missing end position of the context being understood to mean that the remainder of the text message from position 0 onwards has the romantic context applied to it. In a further alternative embodiment, the metadata transmitted for this scenario can be “[context:romantic]”, which can be understood to indicate that the romantic context applies to the entire text message. The user can then send the text message by activating the send button 82 or the return key 96.

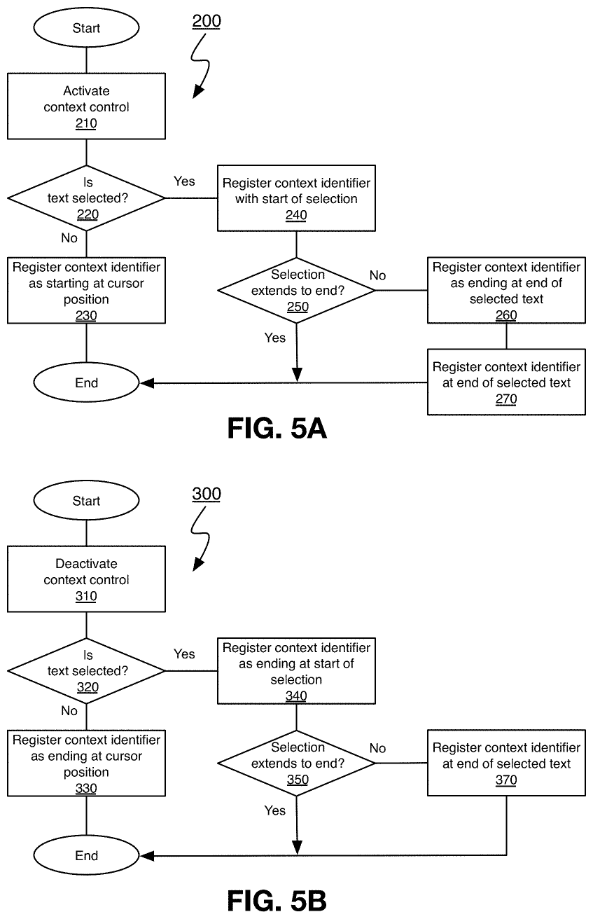

FIG. 5A shows a general method 200 carried out by the text messaging electronic device 20 of generating context metadata for with text messages when a context control is activated by a user. The method 200 commences with the activation of a context control 84 (210). When a context control 84 is activated, the text messaging electronic device 20 determines whether a string of text is selected (220). In particular, it is determined if there is text in the message composition region 88 that has been selected such as by tapping and holding on characters to start the selection, and adjusting the selection. If no text has been selected at the time that the context control 84 is activated, the text messaging application registers a context identifier for the activated context control 84 as starting at the cursor position (230), after which the method 200 ends. If the context control 84 activated is the generic context, the text messaging application does not register a context identifier for the activated context control 84, as the text messaging system assumes that text is associated with the default generic context in the absence of a context identifier. If, instead, at 220, it is determined that text is selected when the context control 84 is activated, the text messaging application registers a context identifier for the activated context control 84 as starting at the start of the selected text (240). Next, the text messaging application determines if the selection extends to the end of the text string in the message composition region 88 (250). If the selection is determined to extend to the end of the text string in the message composition region 88 at 250, the method 200 ends. If, instead, it is determined at 250 that the selection does not extend to the end of the text string in the message composition region 88, the text messaging application registers a context identifier for the activated context control 84 as ending at the end of the selected text (260). In addition, the text messaging application determines if the portion of the text string immediately after the selected text had an context identifier applied to it, and registers the context identifier as starting at the end of the selected text (270), after which the method ends.

FIG. 5B shows a general method 200 carried out by the text messaging electronic device 20 of generating context metadata for with text messages when a context control is deactivated by a user. As previously noted, in the present embodiment, context controls 84 are exclusively activatable. Thus, a context control 84 is deactivated by a user by activating another context control 84. In another exemplary embodiment, however, the text messaging application can enable a user to deactivate a context control by tapping again on the context control 84 that is activated.

The method 300 commences with the deactivation of a context control 84 (310). When a context control 84 is deactivated, the text messaging electronic device 20 determines whether a string of text is selected (320). In particular, it is determined if there is text in the message composition region 88 that has been selected such as by tapping and holding on characters to start the selection, and adjusting the selection. If no text has been selected at the time that the context control 84 is activated, the text messaging application registers a context identifier for the deactivated context control 84 as ending at the cursor position (330), after which the method 300 ends. If the context control 84 deactivated is the generic context, the text messaging application does not register a context identifier for the deactivated context control 84, as the text messaging system assumes that text is associated with the default generic context in the absence of a context identifier. If, instead, at 320, it is determined that text is selected when the context control 84 is deactivated, the text messaging application registers a context identifier for the deactivated context control 84 as ending at the start of the selection (340). Next, the text messaging application determines if the selection extends to the end of the text string in the message composition region 88 (350). If the selection is determined to extend to the end of the text string in the message composition region 88 at 250, the method 300 ends. If, instead, it is determined at 350 that the selection does not extend to the end of the text string in the message composition region 88, the text messaging application determines if the portion of the text string immediately after the selected text had an context identifier applied to it immediately prior to the deactivation, and registers the context identifier as starting at the end of the selected text (370), after which the method ends.

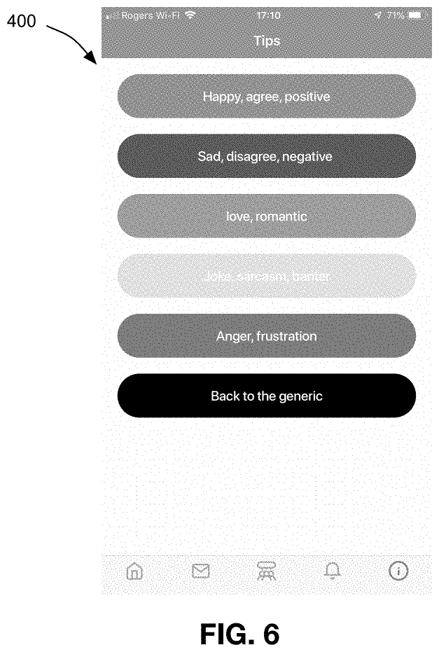

FIG. 6 shows a help screen 400 that provides a more detailed explanation of what each context is. The icons and/or colors selected for the context controls may not be readily understood by some users. The help screen 400 can enable a more detailed explanation of the intended scope of each context for these users so that the meaning of text identified with these contexts can be more clearly understood.

More than one context can be active for a selected portion of a text string. In such cases, the context metadata can have overlapping ranges. For example, using the above approach for registering contexts with portions of text messages, a first context can span a first portion of a text message, and a second context can overlap and span a second portion of the text message. In this example, the context metadata could be “[context:happy start:0 end:42]” and “[context:humor start:29 end:65]”. In such scenarios, the colors associated with the contexts can be used to color different portions of the text. For example a top half of the portion of the text string to which two contexts apply can be colored in a first color associated with a first of the two contexts, and a bottom half of the portion of the text string can be colored with a second color associated with a second of the two contexts.

As will be appreciated, the context identifiers can be registered in other manners for the text messages or portions thereof. For example, each text character can have a vector representing which contexts are active for the character.

In other embodiments, there may be no default context and, thus, context metadata may need to be explicitly defined for all portions of a text message.

Where a physical keyboard is employed, the context controls can be assigned to a key or key combination.

The text messages can be text strings of one or more characters entered by a person via an electronic device. The text message may be directed to another person operating a client, but can also be directed to no particular user and used in combination with contextual metadata provided therewith by a computing device presenting the text message to provide contextual information about the text string or portions thereof.

While, in the above-described embodiment, the contextual metadata/information is employed to alter the color of text displayed on an electronic device, in other embodiments, the contextual metadata can be used to determine how the text is to be displayed in other manners. For example, the font, the size of the font, the boldness of the font, decorations of the font, animations of the font, etc. can be modified during playback by a computing device such as text messaging electronic devices 20 or the text messaging server computer 24.

Further, imagery or colors can be presented along with portions of text strings to denote context as represented by contextual metadata.

The text messaging application can generate output in the form of spoken text via a text-to-speech engine. In this case, the context metadata can modify the intonation of the speech generated by the text-to-speech engine.

The messaging system can enable different levels of each context. For example, the context controls can include plus and minus controls to enable adjustment of a level of the context related to portions of a text message being composed.

In an alternative embodiment, the manner in which context metadata is used to modify playback of the text strings can be customized based on geographic region, user preference, etc. For example, a color can evoke a first emotion in a first cultural environment, and may evoke a significantly different second emotion in a second cultural environment. In such cases, it can be desirable to have customized mappings of the manner in which contextual metadata is presented with or beside the text.

The metadata used to represent the contextual information relating to portions of text messages can be of any suitable form. The contextual metadata can be provided separate from the text string of the text message as described above, or, alternatively, the contextual metadata can be provided in line with the text string via a markup language that can be parsed by an application to separate the text string from the contextual metadata.

Other types of contexts can be represented by the contextual metadata. For example, where a text messaging application is used to communicate both work and personal information to the same parties, the context of portions of the text strings of text messages can be identified as relating to work or personal, to a certain project, to a certain addressee or subset of addressees in a group chat, etc.

Computer-executable instructions for implementing the text messaging application or the text messaging server application on a computer system could be provided separately from the computer system, for example, on a computer-readable medium (such as, for example, an optical disk, a hard disk, a USB drive or a media card) or by making them available for downloading over a communications network, such as the Internet.

While the text messaging server computer is shown as a single physical computer, it will be appreciated that the text messaging server computer can include two or more physical computers in communication with each other. Accordingly, while the embodiment shows the various components of the text messaging server computer residing on the same physical computer, those skilled in the art will appreciate that the components can reside on separate physical computers.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

### LIST OF REFERENCE NUMERALS

20 text messaging electronic device
24 text messaging server computer
28 Internet
32 cellular base station
40 processor
44 storage
48 touchscreen display
52 input/output interface
56 network communications interface
60 local bus
68 user interface
72 message display interface
76 message creation interface
80 soft keyboard
84 context selector control
88 message composition region
92 send control
96 return key
98 name
100 processor
104 RAM
108 input/output interface
112 network communications interface
116 non-volatile storage
120 local bus
124 database
150, 152, 154 text message
200 method
210 activate context control
220 is text selected?
230 register context identifier as starting at cursor position
240 register context identifier with start of selection
250 selection extends to end?
260 register context identifier as ending at end of selected text
270 register context identifier at end of selected text
300 method
310 deactivate context control
320 is text selected?
330 register context identifier as ending at cursor position
340 register context identifier as ending at start of selection
350 selection extends to end?
360 register context identifier at end of selected text
400 help screen

What is claimed is:

1. A text messaging electronic device for registering context, comprising:
at least one processor;
a display coupled to the processor;
a text input interface coupled to the processor;
a network interface coupled to the processor; and
a storage storing computer-readable instructions that, when executed by the at least one processor, cause the at least one processor to execute a text messaging application, the text messaging application having a message display interface and a message creation interface, the message creation interface presenting text entered via the text input interface, and at least one context selector control enabling at least one context to be associated with the text being entered in the message creation interface, the message display interface presenting received text messages and any context identifiers for any contexts associated with the received text messages received from other text messaging systems via the network interface.

2. The text messaging electronic device of claim 1, wherein the at least one context selector control comprises at least one activatable button.

3. The text messaging electronic device of claim 2, wherein the at least one activatable button is toggleable between an activated mode and a deactivated mode, and wherein, when one of the at least one activatable button is in an activated mode, an associated context identifier associated with the one of the at least one activatable button is registered with the text being entered, the context identifier being transmitted with the text when the text is sent via the network interface.

4. The text messaging electronic device of claim 2, wherein, when a portion of the text being entered is selected and one of the at least one activatable button is activated, the context identifier associated with the one of the at least one activatable button is registered with the text being entered, the context identifier being transmitted with the text when the text is sent via the network interface.

5. The text messaging electronic device of claim 2, wherein the at least one activatable button comprises at least one activatable icon.

6. The text messaging electronic device of claim 5, wherein each of the at least one activatable icon conveys the context associated with the activatable icon.

7. A server computer storing text and context, comprising:
at least one processor;
a display coupled to the processor;
a network interface coupled to the processor; and
a storage storing a plurality of text messages, and for each of the plurality of text strings, a sender identifier and at least one recipient identifier, a set of context identifiers identifying at least one context for portions of the plurality of text strings, and computer-readable instructions that, when executed by the at least one processor, cause the at least one processor to execute a server application, the server application receiving text strings and context identifiers identifying at least one context for portions of the text strings.

8. The server computer of claim 7, wherein the plurality of text strings comprise text messages, and wherein the server computer stores a sender account identifier and at least one recipient account identifier for each text message, and communicating, via the network interface, a subset of the text messages to an electronic device together with the context identifiers identifying at least one context for portions of the subset of the text messages.

9. An electronic device enabling text and context entry, comprising:
at least one processor;
a display coupled to the processor;
a text input interface coupled to the processor;
a network interface coupled to the processor; and
a storage storing computer-readable instructions that, when executed by the at least one processor, cause the at least one processor to execute a text entry application, the text entry application having a text string creation interface presenting text entered via the text input interface, and at least one context selector control enabling at least one context to be associated with the text being entered in the text string creation interface.

10. The electronic device of claim 9, wherein the at least one context selector control comprises at least one activatable button.

11. The electronic device of claim 10, wherein the at least one activatable button is toggleable between an activated mode and a deactivated mode, and wherein, when one of the at least one activatable button is in an activated mode, an associated context identifier associated with the one of the at least one activatable button is registered with the text being entered, the context identifier being transmitted with the text when the text is sent via the network interface.

12. The electronic device of claim 10, wherein, when a portion of the text being entered is selected and one of the at least one activatable button is activated, the context identifier associated with the one of the at least one activatable button is registered with the text being entered, the context identifier being transmitted with the text when the text is sent via the network interface.

13. The electronic device of claim 10, wherein the at least one activatable button comprises at least one activatable icon.

14. The electronic device of claim 13, wherein each of the at least one activatable icon conveys the context associated with the activatable icon.
